(19) United States
(12) Patent Application Publication
(10) Pub. No.: US 2014/0015503 A1
(43) Pub. Date: Jan. 16, 2014

(54) BOOT-STRAP CIRCUIT AND VOLTAGE CONVERTING DEVICE THEREOF

(71) Applicant: ANPEC ELECTRONICS CORPORATION, Hsin-Chu (TW)

(72) Inventor: Chieh-Wen Cheng, Hsinchu City (TW)

(73) Assignee: ANPEC ELECTRONICS CORPORATION, Hsin-Chu (TW)

(21) Appl. No.: 13/659,921

(22) Filed: Oct. 25, 2012

(30) Foreign Application Priority Data
Jul. 12, 2012 (TW) 101125156

(51) Int. Cl. H02M 3/07; G05F 1/46

(52) U.S. Cl. 323/282; 327/589

(57) ABSTRACT

A boot-strap circuit for a voltage converting device includes a boot-strap capacitor; a charging module, for charging the boot-strap capacitor; and a protection module, for detecting a capacitor voltage of the boot-strap capacitor and adjusting conducting statuses of one of an upper-bridge switch and a lower-bridge switch of the voltage converting device according to the capacitor voltage and a duty cycle signal utilized for controlling conducting statuses of the upper-bridge switch and the lower-bridge switch.

### BACKGROUND OF THE INVENTION

1. Field of the Invention

The present invention relates to a boot-strap circuit for a voltage converting device, and more particularly, to a boot-strap circuit capable of controlling the conducting statuses of one of an upper-bridge switch and a lower-bridge switch of the voltage converting device according to a voltage of a boot-strap capacitor.

2. Description of the Prior Art

Electronic devices are usually comprised of many different elements, which operate with different operational voltages. It is necessary to utilize different DC-DC voltage converters in order to achieve different voltage modulations, such as modulation for raising voltage values or degradation voltage values, and to maintain predetermined voltage values. Many types of DC-DC voltage converters which are widely employed are derived from the buck/step down converter or the boost/step up converter. The buck converter can decrease an input DC voltage to a default voltage level, and the boost converter can increase the input DC voltage to another default voltage level. Both the buck and boost-type converters have been varied and modified to conform to different system architectures and requirements.

Please refer to FIG. 1, which illustrates a schematic diagram of a conventional boot-strap circuit 106 being utilized in a buck converter 10. The boot-strap circuit 106 comprises a boot-strap capacitor C_BS and a charging module 108. The charging module 108 is utilized for charging the boot-strap circuit C_BS. In this embodiment, the charging module 108 is a diode D_BS, but is not limited herein. The buck converter 10 further includes a driving stage circuit 100, an output stage circuit 102 and a feedback control module 104. The driving stage circuit 100 generates an upper-bridge control signal UG and a lower-bridge control signal LG according to a duty cycle signal DUT, for controlling conducting statuses of an upper-bridge switch US and a lower-bridge switch LS in order to output a switch signal to a node Y. The output stage circuit 102 coupled to the node Y includes an inductor L and a capacitor C. The output circuit 102 utilizes the switch signal and the inductor L to operate a power switch at an output end OUT. The feedback control module 104 is utilized for generating the duty cycle signal DUT according to a feedback voltage VFB generated by feedback resistors R1, R2. In order to save layout area of an integrated circuit, the upper-bridge switch US and the lower-bridge switch LS are preferably realized by N-MOS transistors. The boot-strap circuit 106 charges the node X of the boot-strap capacitor C_BS according to the conducting operations of the upper-bridge switch US and the lower-bridge switch LS, for providing appropriate capacitor voltages V_BS to the driving stage circuit 100. The driving stage circuit 100 can then generate the upper-bridge control signal UG at a high voltage level, for normally conducting the upper-bridge switch US.

The feedback control circuit 104 may control the driving stage circuit 100 to simultaneously disconnect the upper-bridge switch US and the lower-bridge LS when the output end OUT is coupled to a light load. Since there is no charging/discharging path for the boot-strap circuit 106, the boot-strap capacitor C_BS cannot be charged. The voltage difference across the boot-strap capacitor C_BS will be decreased along with the operations of the buck converter 10, resulting in the driving stage circuit 100 being unable to generate the upper-bridge control signal UG at a sufficiently high voltage level to normally conduct the upper-bridge switch US. The buck converter 10 may output a wrong output voltage at the output end OUT. In other words, if the charging module 108 cannot charge the boot-strap capacitor C_BS in a timely fashion for maintaining the capacitor voltage V_BS at a certain voltage level, the driving stage circuit 100 cannot generate the upper-bridge control signal UG at the sufficiently high voltage level. The buck converter 10 may work abnormally as a result.

### SUMMARY OF THE INVENTION

Therefore, the present invention provides a boot-strap circuit for a voltage converting device.

The present invention discloses a boot-strap circuit for a voltage converting device. The boot-strap circuit includes a boot-strap capacitor; a charging module, for charging the boot-strap capacitor; and a protection module, for detecting a capacitor voltage of the boot-strap capacitor and adjusting conducting statuses of one of an upper-bridge switch and a lower-bridge switch of the voltage converting device according to the capacitor voltage and a duty cycle signal utilized for controlling conducting statuses of the upper-bridge switch and the lower-bridge switch.

The present invention further discloses a voltage converting device. The voltage converting device includes an inductor, coupled between an output end and a first node; an upper-bridge switch, coupled between an input end and the first node, for controlling a connection between the input end and the first node according to an upper-bridge control signal; a lower-bridge switch, coupled between the first node and ground, for controlling a connection between the first node and ground according to a lower-bridge control signal; a driving circuit, coupled to the upper-bridge switch and the lower-bridge switch, for generating the upper-bridge control signal and the lower bridge control signal according to a duty cycle signal and a modulation signal; a feedback control circuit, coupled to the output end, for generating the duty cycle signal according to an output voltage of the output end; and a boot-strap circuit, including a boot-strap capacitor; a charging module, for charging the boot-strap capacitor; and a protection module, for detecting a capacitor voltage of the boot-strap capacitor and adjusting conducting statuses of one of the upper-bridge switch and the lower-bridge switch according to the capacitor voltage and a duty cycle signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional boot-strap circuit being utilized in a buck converter.

FIG. 2 is a schematic diagram of a voltage converting device according to an embodiment of the present invention.

FIG. 3 is a schematic diagram of a realization method of the protection module shown in FIG. 2.

FIG. 4A and FIG. 4B are schematic diagrams of related signals when the protection module shown in FIG. 3 operates.

FIG. 5 is a schematic diagram of another realization method of the protection module shown in FIG. 2.

FIG. 6 is a schematic diagram of another voltage converting device according to an embodiment of the present invention.

### DETAILED DESCRIPTION

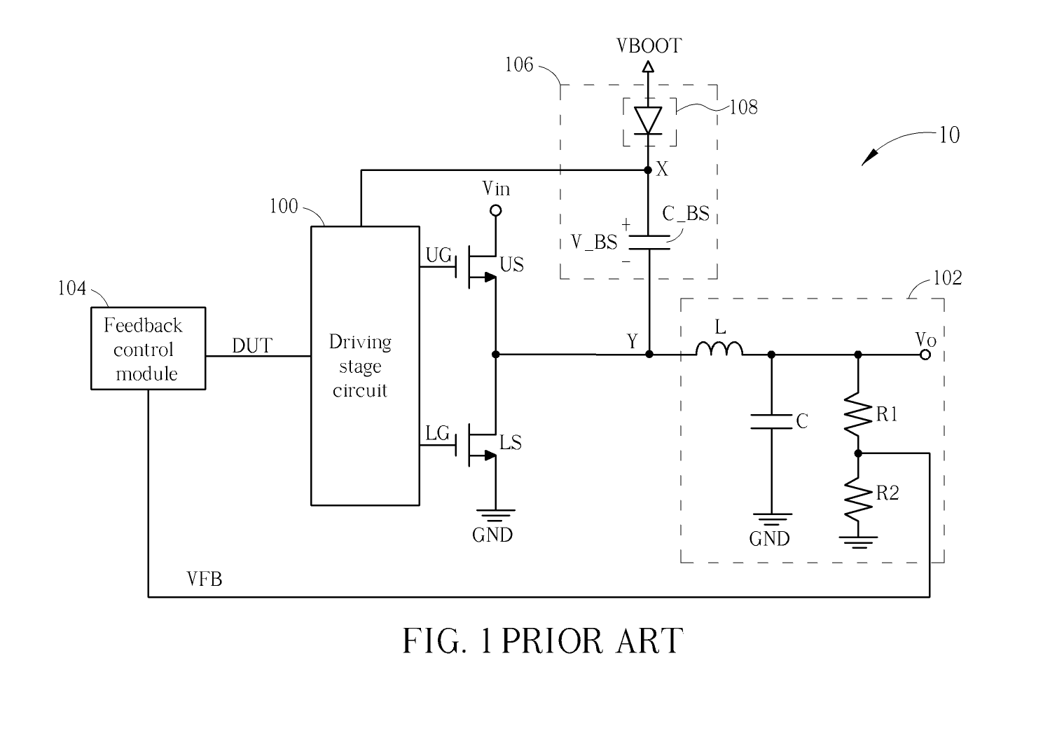

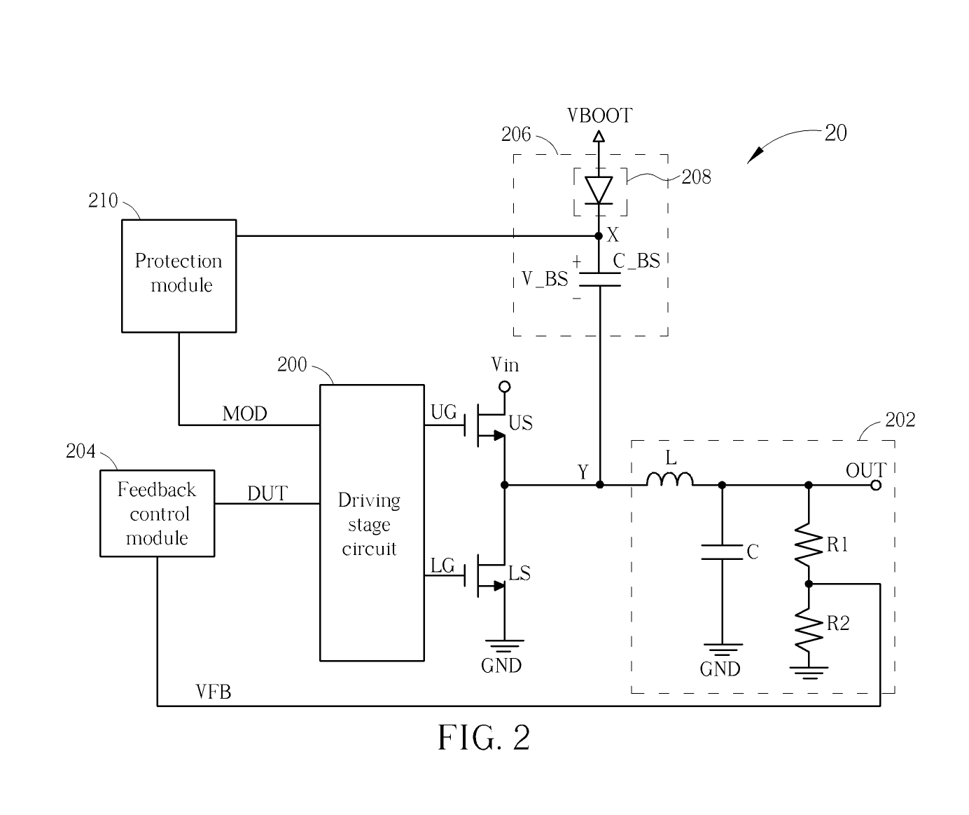

Please refer to FIG. 2, which is a schematic diagram of a voltage converting device 20 according to an embodiment of the present invention. The voltage converting device 20 is utilized for converting an input voltage VIN to an output voltage VOUT in the appropriate voltage level. As shown in FIG. 2, the voltage converting device 20 includes a driving stage circuit 200, an output stage circuit 202, a feedback control module 204 and a boot-strap circuit 206. The structure of the voltage converting device 20 is similar to that of the voltage converting device 10 shown in FIG. 1, thus the components and signals which perform similar functions use the same symbols. Different from the voltage converting device 10 shown in FIG. 1, the boot-strap circuit 206 further includes a protection module 210. The protection module 210 is utilized for detecting the capacitor voltage V_BS of the boot-strap capacitor C_BS and accordingly controlling the conducting statuses of one of the upper-bridge switch US and the lower-bridge switch LS, to avoid the voltage converting device 20 working abnormally due to a decrease in the capacitor voltage V_BS of the boot-strap capacitor C_BS.

In detail, when determining the capacitor voltage V_BS cannot normally drive the driving stage circuit 200 according to the duty cycle signal DUT, the protection module 210 outputs a modulation signal MOD for instructing the driving stage circuit 200 to periodically conduct one of the upper-bridge switch US and the lower-bridge switch LS in a specific period T. The charging module 208 then charges the boot-strap capacitor C_BS during the specific period T and maintains the capacitor voltage V_BS beyond a certain voltage level. The driving stage circuit 200 can output the upper-bridge control signal UG having an appropriate voltage level for ensuring the voltage converting device 20 works normally. When controlling the driving stage circuit 200 to periodically switch the upper-bridge switch US from conductive to nonconductive and then conduct the lower-bridge switch LS, or to periodically conduct the lower-bridge switch LS, the protection module 210 detects the capacitor voltage V_BS and then accordingly adjusts the specific period T of periodically conducting one of the upper-bridge switch US and the lower-bridge switch LS. The protection module 210 can thereby optimize the power consumption of the boot-strap circuit 206 and can prevent the voltage converting device 20 from working abnormally.

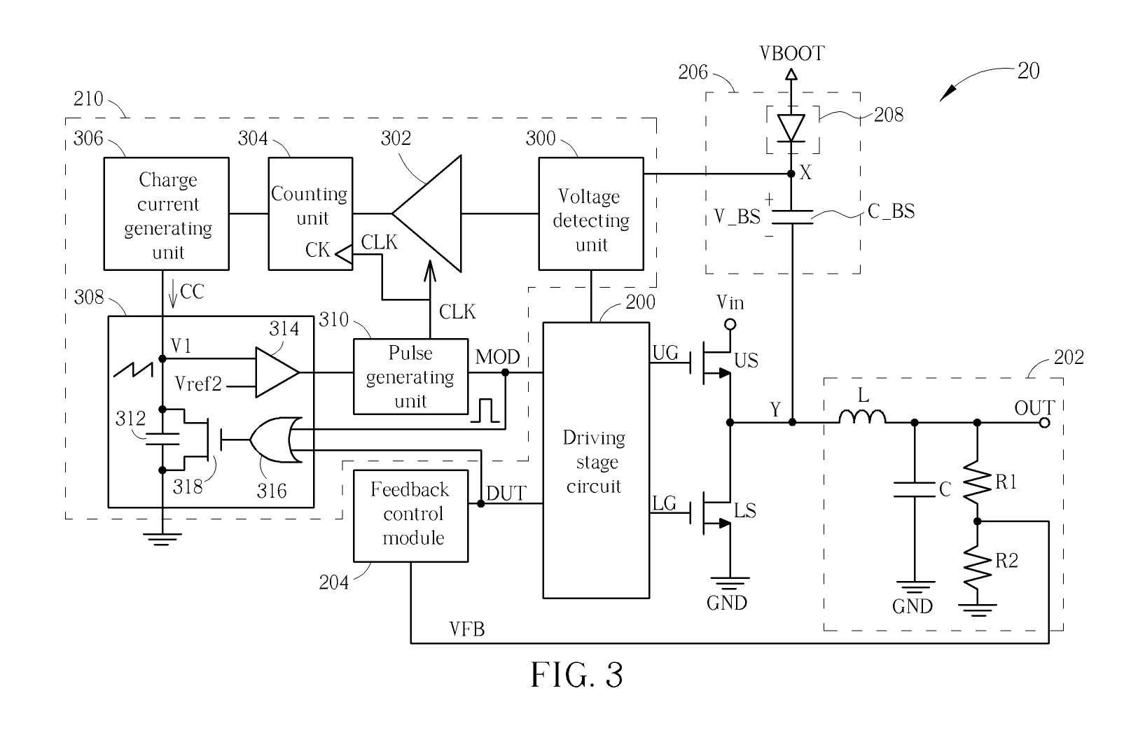

The protection module 210 may be realized by various methods. Please refer to FIG. 3, which is a schematic diagram of a realization method of the protection module shown in FIG. 2. As shown in FIG. 3, the protection module comprises a detecting unit 300, a comparing unit 302, a counting unit 304, a charge current generating unit 306, a timing control unit 308 and a pulse generating unit 310. The detecting unit 300 is coupled to the node X (i.e. the node of the boot-strap capacitor C_BS is coupled to the charging module 208), for detecting the capacitor voltage V_BS and then outputting the capacitor voltage V_BS to the comparing unit 302. Please note that, if the protection module 210 controls the driving stage circuit 200 to periodically conduct the lower-bridge switch LS in the specific period T, the voltage of the node Y is the ground voltage when the lower-bridge switch LS is conductive. Thus, the detecting unit 300 detects the voltage of node X LS as the capacitor voltage V_BS when the protection module 210 forcibly conducts the lower-bridge switch. If the protection module 210 controls the driving stage circuit 200 to periodically conduct the upper-bridge switch US, the voltage of the node Y equals the ground voltage minus a production of the current flow through the lower-bridge switch LS and the conductive resistance of the lower-bridge switch LS when the lower-bridge switch LS is conductive after the upper-bridge switch US is switched from conductive to nonconductive. Since the voltage of the node Y is substantially close to the ground voltage (i.e. the current flow through the lower-bridge switch LS is substantially close to 0), the lower-bridge switch LS will be conductive after the upper-bridge switch US is switched from conductive to nonconductive. Thus, the protection module 210 also detects the voltage of the node X as the capacitor voltage V_BS when the lower-bridge switch LS is conductive after the upper-bridge switch US is switched from conductive to nonconductive. In brief, via detecting the capacitor voltage V_BS at different timings, the detection unit 300 acquires the capacitor voltage V_BS of the capacitor C_BS by only coupling to the node X. In other embodiments, the detecting unit 300 may be both coupled to the node X and the node Y (the connection between the node Y and the detecting unit 300 is not shown in FIG. 3), and may detect the voltage difference between the node X and the node Y as the capacitor voltage V_BS when the protection module 210 forcibly conducts the upper-bridge switch US or the lower-bridge switch LS.

The comparing unit 302 may be a strobed comparator for comparing the capacitor voltage V_BS outputted by the detecting unit 300 and a reference voltage VREF1 according to a clock signal CLK. The comparing unit 302 outputs a comparing signal COM to the counting unit 304 in the specific period T. The counting unit 304 is utilized for adjusting a current parameter CP according to the comparing signal COM and the clock signal CLK, and then outputting the current parameter CP to the charge current generating unit 306. The charge current generating unit 306 generates a charge current CC to the timing control unit 308 according to the current parameter CP. The timing control unit 308 includes a capacitor 312, a comparator 314, an OR gate 316 and a transistor 318 and is utilized for generating a clock control signal TCON to the pulse generating unit 310 according to the charge current CC, the duty cycle signal DUT and the modulation signal MOD. The pulse generating unit 310 is utilized for generating the clock signal CLK and the modulation signal MOD according to the clock control signal TCON. As a result, the protection module 210 shown in FIG. 3 generates the modulation signal MOD according to the duty cycle signal DUT and the capacitor voltage V_BS, for adjusting the conducting statuses of the upper-bridge switch US or the lower-bridge switch LS in the appropriate period T, to ensure the voltage converting device 20 works normally with a minimum power consumption.

In this embodiment, the protection module 210 controls the driving stage 200 to conduct the lower-bridge switch LS according to the duty cycle signal DUT and the capacitor voltage V_BS. When the protection module 210 determines the capacitor voltage V_BS of the boot-strap capacitor C_BS cannot normally drive the driving stage circuit 200 (e.g. when the duty cycle signal DUT does not conduct the upper-bridge switch US or the lower-bridge switch LS in a long period or when the capacitor voltage V_BS is smaller than a threshold voltage), the pulse generating unit 310 generates a pulse in the modulation signal MOD for controlling the driving stage circuit 200 to conduct the lower-bridge switch LS for a specific time CT. Within the specific time CT, the charging module 208 charges the boot-strap capacitor C_BS for increasing the capacitor voltage V_BS to a voltage VBOOT (e.g. the input voltage VIN). At the same time, the pulse generating unit 310 uses the clock signal CLK for instructing a clock period to begin. The comparing unit 302 starts to compare the uncharged capacitor voltage V_BS and the reference voltage VREF1 and outputs the comparing signal COM to the counting unit 304. The counting unit 304 adjusts the current parameter CP according to the comparing signal COM when the clock signal CLK instructs the clock period to begin. For example, if the comparing signal COM instructs the capacitor voltage V_BS to be greater than the reference voltage VREF1, the counting unit 304 decreases the current parameter CP; whereas, if the comparing signal COM instructs the capacitor voltage V_BS to be smaller than the reference voltage VREF1, the counting unit 304 increase the current parameter CP. The charge current generating unit 306 generates the charge current CC according to the current parameter CP for charging the capacitor 312 of the timing control unit 208. In this embodiment, the charge current CC generated by the charge current generating unit 306 is proportional to the current parameter CP.

As a result, a voltage V1 of the node N1 (i.e. the node of the charge current generating unit 306 coupled to the capacitor 312) is increased from the ground voltage in a constant slope (i.e. the ratio between the current value of the charging current CC and the capacitance of the capacitor 312). Then, the comparator 314 of the timing control unit 308 outputs an appropriate timing control signal TCON when the voltage V1 reaches a reference voltage VREF2 (i.e. the time that the voltage V1 is increased from the ground voltage to the reference voltage VREF2 is the specific period T), for controlling the pulse generating unit 310 to instructs a next clock period to begin in the clock signal CLK. At this point, the pulse generating unit 310 also generates the appropriate modulation signal MOD to the driving stage circuit 200, for controlling the driving stage circuit 200 to conduct the lower-bridge switch LS to allow the charging module 208 to charge the boot-strap capacitor C_BS. The modulation signal MOD also conducts the transistor 318 through the OR gate 316, to reset the voltage V1 to the ground voltage.

In short, the protection module 210 conducts the lower-bridge switch LS during the specific period T via co-operations between the charge current generating unit 306 and the timing control unit 308. The protection module 210 adjusts the charge current CC (i.e. the specific period T) via comparing the capacitor voltage V_BS and the reference voltage VREF1 when the lower-bridge switch LS is conductive. If the capacitor voltage V_BS is greater than the reference voltage VREF1 when the lower-bridge switch LS is conductive, the capacitor voltage V_BS will be greater than the reference voltage VREF1 within the specific period T. The charge current CC can be decreased (i.e. the specific period T can be prolonged) and this does not result in the voltage converting device 20 working abnormally. If the capacitor voltage V_BS is smaller than the reference voltage VREF1 when the lower-bridge switch LS is conductive, the capacitor voltage V_BS will be smaller than the reference voltage VREF1 within the specific period T. The charge current CC is increased (i.e. the specific period is shortened), for ensuring the voltage converting device 20 works normally. Preferably, as long as the current scales of the charge current generating unit 306 is small enough, the protection module 210 can optimize the specific period T, such that the capacitor voltage V_BS is exactly greater than the reference voltage VREF1 at the end of the optimized specific period T. In other words, the protection module 210 will maintain the capacitor voltage V_BS to be greater than the reference voltage VREF1. Then, the driving stage circuit 200 can generate the upper-bridge control signal UG with the sufficiently high voltage level and the voltage converting device 20 works normally.

Please note that, if the charging module 208 charges the boot-strap capacitor C_BS within the time that the protection module counts the specific period T (e.g. the duty cycle signal DUT instructs the driving stage circuit 200 to conduct the lower-bridge switch LS), the duty cycle signal DUT will conduct the transistor 318 via the OR gate 316, for resetting the voltage V1 to the ground voltage. Accordingly, the voltage V1 is increased from the ground voltage again. In other words, if the charge module 208 charges the boot-strap capacitor C_BS within the time that the protection module counts the specific period T, the protection module 210 does not control the driving stage circuit 200 to forcibly conduct the lower-bridge switch LS during the specific period T.

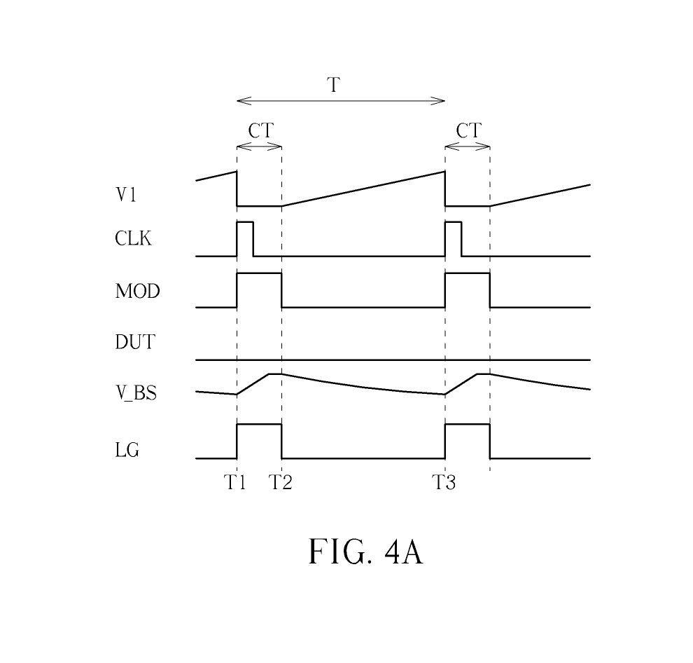

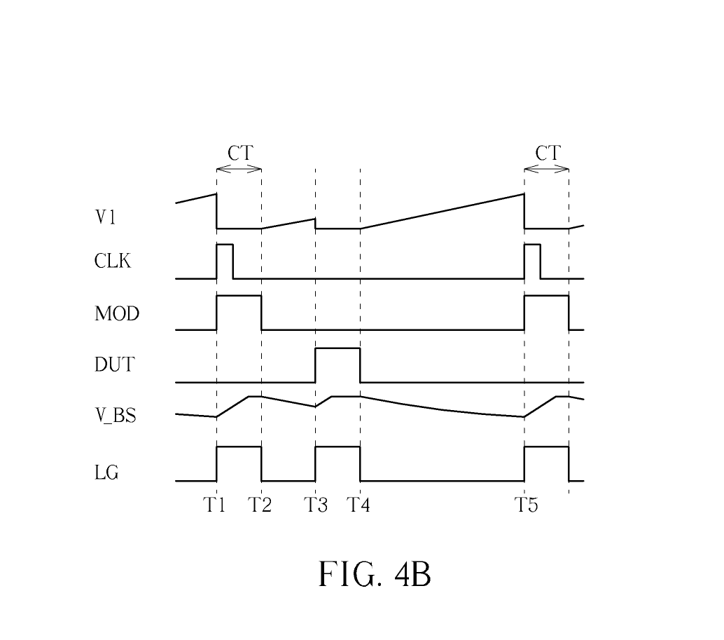

Please refer to FIG. 4A, which is a schematic diagram of related signals when the protection module 210 shown in FIG. 3 operates. As shown in FIG. 4A, if the charging module 208 does not charge the boot-strap capacitor C_BS within a long period (e.g. the duty cycle signal DUT does not conduct the upper-bridge switch US and the lower-bridge switch LS within a long period), the modulation module MOD generates a pulse at a time T1 resulting in a corresponding pulse being generated in the lower-bridge control signal LG. The lower-bridge switch LS is conductive for a specific time CT due to the pulse in the lower-bridge control signal LG; the charging module 208 then charges the boot-strap capacitance C_BS. At the same time, the voltage V1 is reset to the ground voltage by the modulation signal MOD. The clock signal CLK also generates a pulse at the time T1 for instructing the comparing unit 302 to output the comparing signal COM, such that the counting unit 304 adjusts the charging current CC generated by the charge current generating unit 306 according to the comparing signal COM. The pulse in the modulation signal MOD ends at a time T2. The voltage V1 starts to rise in a constant slope and the capacitor voltage begins to drop. Next, the voltage V1 reaches the reference voltage VREF2 at a time T3. The clock signal CLK and the modulation signal MOD both generate a pulse according to the timing control signal TCON, such that the voltage converting device 20 repeats the operations within the time T1 and the time T2. As a result, the protection module 210 periodically conducts the lower-bridge switch LS in a specific period T when the charging module 208 does not charge the boot-strap capacitor within a long period, to allow the charging module 208 to charge the boot-strap capacitor C_BS. Moreover, the protection module 210 optimizes the specific time T via the detecting capacitor voltage V_BS when the lower-bridge switch LS is periodically conductive.

Please refer to FIG. 4B, which is another schematic diagram of related signals when the protection module 210 shown in FIG. 3 operates. Similarly, the modulation signal MOD generates a pulse at the time T1 resulting in the corresponding pulse being generated in the lower-bridge control signal LG. The lower-bridge switch LS is conductive for a specific time CT due to the pulse in the lower-bridge control signal LG; the charging module 208 then charges the boot-strap capacitance C_BS. The clock signal CLK also generates a pulse at the time T1 for instructing the comparing unit 302 to output the comparing signal COM, such that the counting unit 304 adjusts the charging current CC generated by the charge current generating unit 306 according to the comparing signal COM. The pulse in the modulation signal MOD ends at a time T2. The voltage V1 starts to rise in a constant slope and the capacitor voltage begins to drop. Different from FIG. 4A, the duty cycle signal DUT instructs the driving stage circuit 200 to conduct the lower-bridge switch LS from the time T3 to the time T4. Thus, the voltage V1 is reset to the ground voltage. After the specific period T, the voltage V1 reaches the reference voltage VREF2 at the time T5. The pulses are generated in the clock signal CLK and the modulation signal MOD for conducting the lower-bridge switch LS. The charging module 208 is allowed to charge the boot-strap capacitor C_BS.

Please note that the main spirit of the present invention is controlling the conducting statuses of the upper-bridge switch US or the lower-bridge switch LS with the specific period T via detecting the capacitor voltage C_BS of the boot-strap capacitor C_BS. Thus, the capacitor voltage V_BS will be greater than the reference voltage VREF1 within the operations and the voltage converting device 20 will work normally. When controlling the upper-bridge switch US or the lower-bridge switch LS with the specific period T, the specific period T is optimized via comparing the capacitor voltage V_BS and the reference voltage VREF1. As a result, the goal of preventing the voltage converting device 20 from working abnormally is achieved with the minimum power consumption. According to different applications, those skilled in the art may accordingly observe appropriate alternations and modifications. For example, the protection module 210 may fix the specific period T and achieve the goal of optimizing the boot-strap circuit 206 via other methods. In an embodiment, the protection module 210 may adjust the conducting time of periodically conducting one of the upper-bridge switch US and the lower-bridge switch LS (i.e. the specific time CT shown in FIG. 4A) for optimizing the power consumption of the boot-strap circuit 206. In another embodiment, the protection module 210 may adjust the specific period T via charging the maximum current of the inductor L. For example, if the protection module 210 periodically conducts the upper-bridge switch US in the specific period T, the protection module 210 will disconnect the upper-bridge switch US when the upper-bridge switch US is forcibly conductive and the current of the inductor L reaches a current IMAX. Through adjusting the value of the current IMAX, the protection module 210 can adjust the specific period T. Thus, the protection module 210 achieves the goal of optimizing the power consumption of the boot-strap circuit 206.

The protection module 210 can prevent the conducting frequency of the upper-bridge switch US and the lower-bridge switch LS from being lower than 20 kHz according to the duty cycle signal DUT, which eliminates the noise within the audio frequency range (i.e. the noise which can be heard by humans). For example, the specific period T may be set smaller than or equal to 0.05 ms (i.e. the frequency corresponding to the specific period T is greater than 20 kHz).

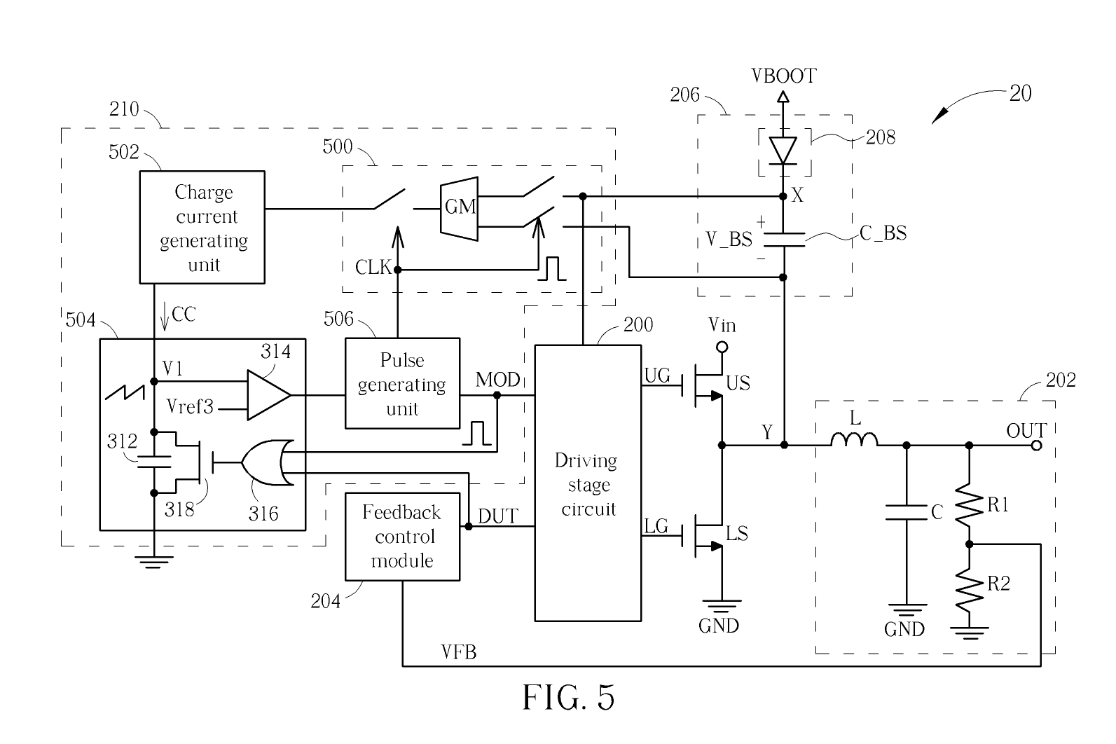

Please refer to FIG. 5, which is a schematic diagram of another realization method of the protection module 210 shown in FIG. 2. The protection module 210 shown in FIG. 5 includes a sampling unit 500, a charge current generating unit 502, a timing control unit 504 and a pulse generating unit 506. The sampling unit 500 includes an operational amplifier GM, for sampling the capacitor voltage V_BS in the specific period T according to the clock signal CLK. Similarly, if the protection module 210 controls the driving stage circuit 200 to periodically conduct the lower-bridge switch LS with the specific period T, the voltage of the node Y is the ground voltage when the lower-bridge switch LS is conductive. Thus, the sampling unit 500 samples the voltage of node X as the capacitor voltage V_BS when the protection module 210 forcibly conducts the lower-bridge switch. In brief, via sampling the capacitor voltage V_BS when the protection module 210 forcibly conducts the lower-bridge switch LS, the sampling unit 500 acquires the capacitor voltage V_BS of the capacitor C_BS by only coupling to the node X. The charge current generating unit 502 is used for generating the charge current CC according to the sampled capacitor voltage V_BS. In this embodiment, the charge current CC is inversely proportional to the capacitor voltage V_BS. The timing control unit 504 and the pulse generating unit 506 are similar to those components shown in FIG. 3, and are not detailed herein for brevity. As a result, the protection module 210 adjusts the charge current CC according to the capacitor voltage V_BS, for adjusting the time of the voltage V1 reaching a reference voltage VREF3 (i.e. the specific period T). Accordingly, when determining the charging module 208 cannot charge the boot-strap capacitor C_BS in a long period according to the duty cycle signal DUT, the protection module 210 forcibly conducts the upper-bridge switch US or the lower-bridge switch LS in the specific period T for allowing the charging module 208 to charge the boot-strap capacitor C_BS. Moreover, since the charge current CC is inversely proportional to the capacitor voltage V_BS, the protection module 210 shown in FIG. 5 adjusts the specific period T according to the capacitor voltage V_BS. The detailed operations of the protection module 210 shown in FIG. 5 can be known by referring to the above, and are therefore not described herein for brevity.

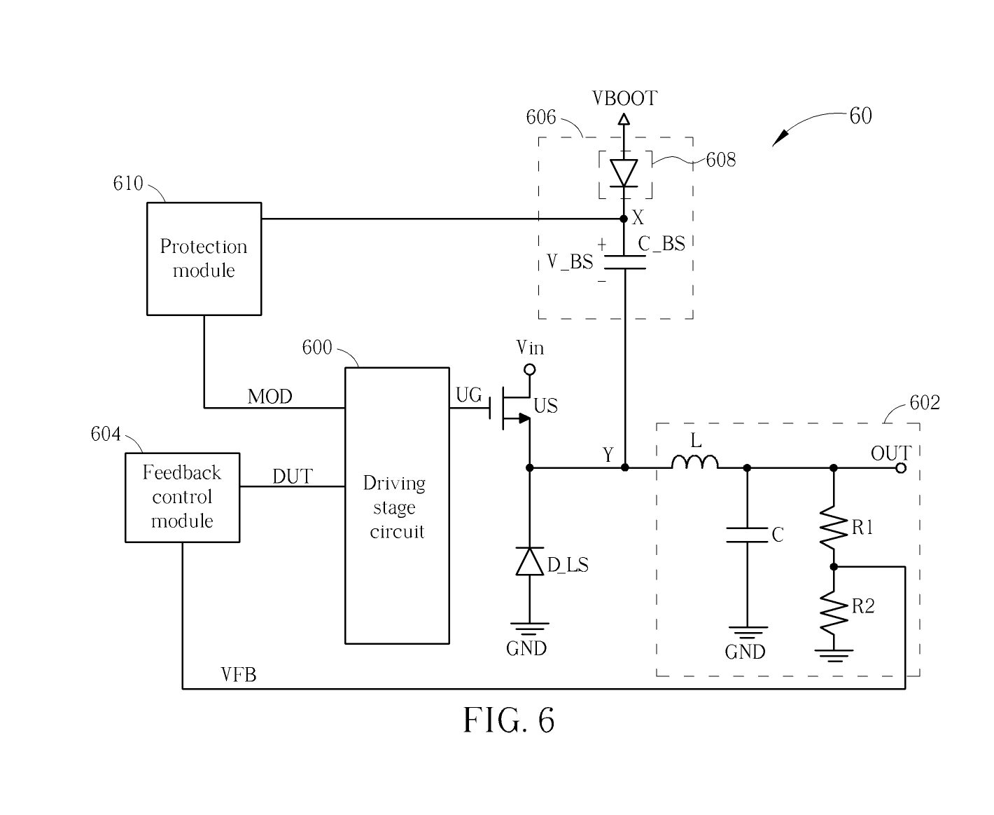

The protection module disclosed by the present invention can be used in the voltage converting device of a non-synchronous buck structure. Please refer to FIG. 6, which is a schematic diagram of a voltage converting device 60 according to an embodiment of the present invention. The voltage converting device 60 adapts the non-synchronous buck structure for converting the input voltage VIN to the output voltage VOUT in an appropriate voltage level. The voltage converting device 60 includes a driving stage circuit 600, an output stage circuit 602, a feedback control module 604 and a boot-strap circuit 606. The voltage converting device 60 is similar to the voltage converting device 20 shown in FIG. 2; the components and signals which perform similar functions therefore use the same symbols. Different from the voltage converting device 20, the low-bridge switch LS is replaced by a diode LS_D. The protection module 610 of the voltage converting device 60 controls the conducting status of the upper-bridge switch US according to the capacitor voltage V_BS of the boot-strap capacitor C_BS, for avoiding the voltage converting device operating abnormally due to a decrease in the capacitor voltage V_BS. Please note that the voltage of the node Y equals the ground voltage minus the PN junction forward biasing voltage VD of the diode LS_D (i.e. the voltage of the node Y is (−VD)) when the upper-bridge switch US is switched from conductive to nonconductive. Since the current flow through the inductor L is substantially zero when the upper-bridge switch US is switched from conductive to nonconductive and the PN junction forward biasing voltage VD of the diode LS_D is substantially a constant value, the protection module 610 acquires the accurate capacitor voltage V_BS via detecting the voltage of the node X when the upper-bridge switch US is switched from conductive to nonconductive. The detailed operations of the voltage converting device 60 can be known by referring to the above, and are therefore not detailed herein for brevity.

To sum up, the boot-strap circuitry disclosed in the above embodiments timely conducts an upper-bridge switch or a lower-bridge switch according to a duty cycle signal and the voltage difference across the boot-strap capacitor for maintaining the voltage difference across the boot-strap capacitor beyond a certain voltage level, which prevents the voltage converting device from working abnormally. Moreover, the boot-strap circuitry disclosed in the above embodiments optimizes power consumption via adjusting the specific period of periodically conducting the upper-bridge switch or the lower-bridge switch, adjusting the conducting time of periodically conducting the upper-bridge switch or the lower-bridge switch or changing the maximum current of the inductor. In short, the boot-strap circuitry disclosed in the above embodiments can achieve the goal of preventing the voltage converting device from working abnormally with optimized power consumption.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A boot-strap circuit for a voltage transforming device, comprising:
a boot-strap capacitor;
a charging module, for charging the boot-strap capacitor; and
a protection module, for detecting a capacitor voltage of the boot-strap capacitor and adjusting conducting statuses of one of an upper-bridge switch and a lower-bridge switch of the voltage converting device according to the capacitor voltage and a duty cycle signal utilized for controlling conducting statuses of the upper-bridge switch and the lower-bridge switch.

2. The boot-strap circuit of claim 1, wherein the capacitor voltage is the voltage difference across the boot-strap capacitor.

3. The boot-strap circuit of claim 2, wherein the protection module detects the capacitor voltage when periodically conducting one of the upper-bridge switch and the lower-bridge switch.

4. The boot-strap circuit of claim 1, wherein the capacitor voltage is the voltage of an end of the boot-strap capacitor coupled to the charging module.

5. The boot-strap circuit of claim 4, wherein the protection module detects the capacitor voltage when periodically conducting the lower-bridge switch.

6. The boot-strap circuit of claim 4, wherein the protection module detects the capacitor voltage when periodically switching the upper-bridge switch from conductive to nonconductive and conducting the lower-bridge switch.

7. The boot-strap circuit of claim 1, wherein the protection module adjusts the conducting statuses of periodically conducting one of the upper-bridge switch and the lower-bridge switch when determining the capacitor voltage cannot normally drive the voltage converting device.

8. The boot-strap circuit of claim 7, wherein the protection module adjusts the conducting statuses of periodically conducting one of the upper-bridge switch and the lower-bridge switch when the capacitor voltage is smaller than a threshold voltage.

9. The boot-strap circuit of claim 7, wherein the protection module adjusts the conducting statuses of periodically conducting one of the upper-bridge switch when the duty cycle signal does not conduct the upper-bridge switch and the lower-bridge switch for a specific period of time.

10. The boot-strap circuit of claim 1, wherein the protection module adjusts a conducting frequency of periodically conducting one of the upper-bridge switch and the lower-bridge switch.

11. The boot-strap circuit of claim 1, wherein the protection module adjusts a conducting time of periodically conducting one of the upper-bridge switch and the lower-bridge switch.

12. The boot-strap circuit of claim 11, wherein the protection module adjusts the conducting time of periodically conducting one of the upper-bridge switch and the lower-bridge switch via limiting a maximum current of an inductor of the voltage converting device.

13. The boot-strap circuit of claim 1, wherein the protection module comprises:
a detection unit, coupled to the boot-strap capacitor for detecting the capacitor voltage according to a clock signal;
a comparing unit, coupled to the detection unit, for periodically comparing the capacitor voltage and a first reference voltage according to the clock signal, in order to output a comparing signal;
a counting unit, coupled to the detection unit, for generating a counting signal according to the clock signal and the comparing signal;
a charge current generating unit, for generating a charge current according to the comparing signal;
a timing control unit, comprising:
a capacitor, coupled to the charge current generating unit, for generating a ramp voltage according to the charge current;
a comparator, for comparing the ramp voltage and a second reference voltage and generating a pulse generating signal at an output end;
an OR gate, for generating a reset signal according to a modulation signal and the duty cycle signal; and
a transistor, for resetting the ramp voltage according to the reset signal; and
a pulse generating unit, coupled to the comparator, for generating the clock signal and the modulation signal according to the pulse generating signal.

14. The boot-strap circuit of claim 1, wherein the protection module comprises:
a sampling unit, coupled to the boot-strap capacitor for sampling the capacitor voltage according to a clock signal to generate a sampling signal;
a charge current generating unit, for generating a charge current according to the sampling signal; and
a timing control unit, comprising:
a capacitor, coupled to the charge current generating unit for generating a ramp voltage according to the charge current;
a comparator, for comparing the ramp voltage and a second reference voltage and generating a pulse generating signal at an output end;
an OR gate, for generating a reset signal according to a modulation signal and the duty cycle signal; and
a transistor, for resetting the ramp voltage according to the reset signal; and
a pulse generating unit, coupled to the comparator for generating the clock signal and the modulation signal according to the pulse generating signal.

15. A voltage converting device, comprising:
an inductor, coupled between an output end and a first node;
an upper-bridge switch, coupled between an input end and the first node, for controlling a connection between the input end and the first node according to an upper-bridge control signal;
a lower-bridge switch, coupled between the first node and ground, for controlling a connection between the first node and ground according to a lower-bridge control signal;
a driving circuit, coupled to the upper-bridge switch and the lower-bridge switch, for generating the upper-bridge control signal and the lower bridge control signal according to a duty cycle signal and a modulation signal;
a feedback control circuit, coupled to the output end, for generating the duty cycle signal according to an output voltage of the output end; and
a boot-strap circuit, comprising:
a boot-strap capacitor;
a charging module, for charging the boot-strap capacitor; and
a protection module, for detecting a capacitor voltage of the boot-strap capacitor and adjusting conducting statuses of one of the upper-bridge switch and the lower-bridge switch according to the capacitor voltage and a duty cycle signal.

16. The voltage converting device of claim 15, wherein the capacitor voltage is the voltage difference across the boot-strap capacitor.

17. The voltage converting device of claim 16, wherein the protection module detects the capacitor voltage when periodically conducting one of the upper-bridge switch and the lower-bridge switch.

18. The voltage converting device of claim 15, wherein the capacitor voltage is the voltage of an end of the boot-strap capacitor coupled to the charging module.

19. The voltage converting device of claim 18, wherein the protection module detects the capacitor voltage when periodically conducting the lower-bridge switch.

20. The voltage converting device of claim 18, wherein the protection module detects the capacitor voltage when periodically switching the upper-bridge switch from conductive to nonconductive and conducting the lower-bridge switch.

21. The voltage converting device of claim 15, wherein the protection module adjusts the conducting statuses of periodically conducting one of the upper-bridge switch and the lower-bridge switch when determining the capacitor voltage cannot normally drive the voltage converting device.

22. The voltage converting device of claim 21, wherein the protection module adjusts the conducting statuses of periodically conducting one of the upper-bridge switch and the lower-bridge switch when the capacitor voltage is smaller than a threshold voltage.

23. The voltage converting device of claim 21, wherein the protection module adjusts the conducting statuses of periodically conducting one of the upper-bridge switch when the duty cycle signal does not conduct the upper-bridge switch and the lower-bridge switch for a specific period of time.

24. The voltage converting device of claim 15, wherein the protection module adjusts a conducting frequency of periodically conducting one of the upper-bridge switch and the lower-bridge switch.

25. The voltage converting device of claim 15, wherein the protection module adjusts a conducting time of periodically conducting one of the upper-bridge switch and the lower-bridge switch.

26. The voltage converting device of claim 15, wherein the protection module adjusts the conducting time of periodically conducting one of the upper-bridge switch and the lower-bridge switch via limiting a maximum current of the inductor.

27. The voltage converting device of claim 15, wherein the protection module comprises:
a detection unit, coupled to the boot-strap capacitor, for detecting the capacitor voltage according to a clock signal;
a comparing unit, coupled to the detection unit, for periodically comparing the capacitor voltage and a first reference voltage according to the clock signal, to output a comparing signal;
a counting unit, coupled to the detection unit, for generating a counting signal according to the clock signal and the comparing signal;
a charge current generating unit, for generating a charge current according to the comparing signal;
a timing control unit, comprising:
a capacitor, coupled to the charge current generating unit, for generating a ramp voltage according to the charge current;
a comparator, for comparing the ramp voltage and a second reference voltage and generating a pulse generating signal at an output end;
an OR gate, for generating a reset signal according to a modulation signal and the duty cycle signal; and
a transistor, for resetting the ramp voltage according to the reset signal; and
a pulse generating unit, coupled to the comparator, for generating the clock signal and the modulation signal according to the pulse generating signal.

28. The voltage converting device of claim 15, wherein the protection module comprises:
a sampling unit, coupled to the boot-strap capacitor, for sampling the capacitor voltage according to a clock signal to generate a sampling signal;
a charge current generating unit, for generating a charge current according to the sampling signal; and
a timing control unit, comprising:
a capacitor, coupled to the charge current generating unit, for generating a ramp voltage according to the charge current;
a comparator, for comparing the ramp voltage and a second reference voltage and generating a pulse generating signal at an output end;
an OR gate, for generating a reset signal according to a modulation signal and the duty cycle signal; and
a transistor, for resetting the ramp voltage according to the reset signal; and
a pulse generating unit, coupled to the comparator for generating the clock signal and the modulation signal according to the pulse generating signal.
